(19) United States
(12) Patent Application Publication
(10) Pub. No.: US 2005/0158161 A1
(43) Pub. Date: Jul. 21, 2005

(54) Wheel-lift device with tongue for towing vehicles -(3)

(76) Inventor: Arden Royce Shubert, Fort Collins, CO (US)

Correspondence Address: Arden Royce Shubert, 1920 Sheely Drive, Fort Collins, CO, 80526, US

(21) Appl. No.: 11/075,987

(22) Filed: Mar. 9, 2005

Related U.S. Application Data
(63) Continuation-in-part of application No. 10/294,258, filed on Nov. 14, 2002.

(51) Int. Cl. B65G 1/00

(52) U.S. Cl. 414/563

(57) ABSTRACT

A wheel-lift device for towing a vehicle, particularly a hitch assembled from several components to hold and carry wheels of a vehicle to be towed in which the device becomes a rigid tongue assembly for that vehicle. The tongue is used to hitch vehicle to a tow truck with both horizontal and vertical axes between vehicles situated at the hitch of the tow truck.

### CROSS-REFERENCE TO RELATED APPLICATION

This is a Continuation-in-Part of application Ser. No. 10/294,258 filed Nov. 14, 2002 and now Patent No. ______, granted ______.

### FEDERALLY SPONSORED RESEARCH

Not Applicable

### SEQUENSE LISTING OR PROGRAM

Not Applicable

### BACKGROUND OF THE INVENTION—FIELD OF THE INVENTION

This invention relates to a wheel-lift device for towing vehicles, and particularly to a device assembled from several parts that surround an axle of a vehicle to be towed, in which the device becomes a rigid appendage to that vehicle and, having that appendage serve as a tongue to hitch to a second vehicle, allows the first vehicle to be towed by the second as a two-wheel cart.

### BACKGROUND OF THE INVENTION

Wheel-lift towing of vehicles has a history of less than four decades. Wagner, U.S. Pat. No. 3,182,829, May 1965, gave us a vehicular lifting yoke. His yoke taught us to use the axle of the towed vehicle as the horizontal axis for articulation between the towed and towing vehicle. It remains common practice to date.

That design has an inherent problem. The location of the horizontal pivot determines the location of where the weight of the towed vehicle is transferred to the tow truck. Truck manufacturers prefer that a truck's load be carried between the axles or close to the rear axle. A recommended ratio of no more than forty percent of cargo weight should be carried behind the axle. This design carries all of the cargo weight some distance behind the axle and the weight of the wheel-lift equipment as well is carried behind the truck's axle in most designs.

Earlier wreckers, especially before about 1980, used a tow bar or a sling that attached to the bumper or the end of the frame of the towed vehicle. The weight of the vehicle was carried by the wrecker at the tow bar that had a working position of several feet behind the end of the truck. In comparison that is about half the distance from the axle that many wheel-lifts carry their load. To compensate for this shift of the load rearward, wreckers are generally at least one and a half times the length of earlier tow trucks and weigh substantially more.

State commercial drivers license manuals teach drivers that they are responsible for their load and that poor distribution of weight can make vehicle handling unsafe. Tow truck operators are generally required to have commercial drivers licenses and to know these rules. It seems inevitable that towmen will be summoned to court sometime in the future for knowingly operating unsafe vehicles.

The industry seems aware of the challenges it faces carrying towing loads far behind tow trucks' rear axles but it appears to have not yet found a solution that addresses the weight transfer problem. An example appears in the Winter 2002 edition of the Write Carrier & Wrecker Quarterly, Volume 11, Number 1, Page 20, a publication of the Jerr-Dan Corporation, a major manufacturer of towing equipment.

This article describes a user's need for equipment to tow a fire truck with a front axle weight of 21,350 pounds, a front axle set back of 10 feet from the front bumper, and the fire truck having a bucket and snorkel assembly that extends 7 feet ahead of the front bumper. The fire trucks have low hanging components within the underbelly of the fire truck that the towing boom needed to pass under without contact when turning. The manufacturer only approves the axle as a pickup point. The fire trucks are too high to transport on trailers.

This customer's problem invites a comparison between the industry's state of art and the present invention. Their solution was to use a modified heavy-duty under-lift carrying the fire truck by the axle using a four stage rigid boom extending behind the truck's tri-axles. The 21,350 pound front axle load of the fire truck is carried about 20 feet behind the center of the tow truck's rear suspension. The rigid lifting boom acts as a lever increasing the 21,350 pound axle weight on the under-lift's axles. Wrecker trucks have a high tare weight. The combined load exceeds the tri-axle legal load weight. The article acknowledges that this combination will be an oversize, over-height, and overweight load.

The present invention shifts both horizontal and vertical axes between the tow truck and the fire truck from the rear of the lifting arm to the front of that arm. The action of the lever on this wheel-lift hitch device arm transfers most of the front axle weight to the tow truck, but a percentage of that weight will be transferred to the rear axles of the towed unit. In this example the fire truck could be towed using the present invention by a tandem axle tractor equipped with a pintle hook hitch and be of legal axle weight on the tow truck's axles. The present invention has no arm that pivots under the load. The load may be carried lower because less clearance beneath the truck is required and the towed load may be under legal height limits. A shorter tow truck can be used because it is not necessary to have excessive tow truck length to counterbalance a load carried far behind the axles of the tow truck. The combination can be within legal length requirements.

An additional problem with the present designs of wheel-lift tow trucks of all sizes and classes is that all carry the load at the end of a boom behind the truck axle. The boom serves as a lever. A lever amplifies motion and force. That amplified motion can cause movement and forces in excess of design capability of the towed vehicle. An irregular or undulating road surface can cause extreme vertical movement in the suspension of the towed vehicle carried on a wheel-lift and retained to that boom and can result in damage to that vehicle.

To avoid some of this damage users can raise the boom to relatively high angles from horizontal to provide more clearance between the boom, its pivot, and drive train components of the towed vehicle. This action causes a different problem. Many tow truck designs advertise a wheel-lift boom angle of 10 to 15 degrees above horizontal. When a boom is raised to that angle, the pivot pin between the boom and the transverse bar of the wheel lift also tilts forward at a like angle. The forward tilt of the transverse bar's pivot pin causes the towed vehicle to warp in a turn in relation to the attitude of the tow truck. The actual warp between the inside and outside ends of the transverse bar in a 45 degree turn may be 12 inches or more when the boom is carried at these angles. Cullum, U.S. Pat. No. 5,709,522, January 1998, introduced a double pivot crossbar “capable of rotational movement in both horizontal and vertical planes permitting stress reduction in both the tow truck assembly and the tow truck chassis . . . . ” Presumably it may also reduce stress to the towed vehicle that is generally less strong than towing equipment.

Available alternatives to a wheel-lift tow truck are limited. Car carriers are widely used by professional towing operators. Their size is generally a disadvantage. Three car lengths of space are generally required to load or unload a car carrier compared to two car lengths of space with most wheel lift trucks. That space requirement can limit the efficiency of a car carrier in an urban environment. A second problem with car carriers is the difficulty of damage free loading of a vehicle with front wheels locked at an angle. Force rather than finesse generally prevails and the locked vehicle is dragged onto a truck causing strain on mechanical components. Alm, U.S. Pat. No. 5,779,431, July 1998, introduced a wheel-loading device used on a car carrier body to facilitate damage-free loading. It appears to be the only wheel-lift design at this time that carries its load primarily between the axles of the truck during transport.

Car dollies also carry vehicles on their own wheels and suspension. Car dollies have only limited capabilities for handling damaged or inoperable vehicles. Most designs include two vertical axes, one at the hitch and a second at the wheels of the towed vehicle. Few operators are able to back up such a combination and commercial use is therefore limited.

A wheel-lift device seldom seen in the United States is a truck mounted rotating boom equipped with a rotating lift frame at its outer end. The lift frame is maneuvered over the vehicle and wheel supports attached to the lift frame are placed under each wheel. The vehicle is then hoisted onto the truck body. It appears to be an especially efficient approach for the damage-free removal of illegally parked vehicles.

A different under-lift towing device is an alternative to the traditional wheel-lift or under-lift. Marketed under the trade name “Tru-Hitch”, it is an under-lift for heavy duty towing that uses the 5th wheel of a semi-truck tractor as the horizontal and vertical towing axes. It was introduced into the commercial market about 1990 and is a towing system that carries the weight of the towed vehicle above the axle of the tow truck. It lacks convenience for use in its method of attachment to the vehicle to be towed.

The automotive wheel-lift has long been used as both horizontal and vertical axes between the towed vehicle and the tow truck. There appears to be no precedent for a wheel-lift to not use the vehicle wheels as a horizontal axis and instead immobilize it and use the immobilized axle to support a fixed tongue. A wheel-lift hitch does not appear to have been used to transfer the horizontal and vertical axes to the front by a tongue to a hitch ahead of the towed vehicle. There is no precedent for a wheel-lift device that is assembled at the vehicle axle creating a tongue with which to tow that vehicle and then carrying it on its own wheels and suspension.

Devices for lifting a heavy tongue from the ground into a towing hitch on a truck are readily available and in widespread use, especially in the modular and mobile home transporting business. Charles Weber, U.S. Pat. No. 4,000,911, Jan. 1977, introduced a hitch head that was hydraulically adjustable laterally, vertically, and longitudinally. Randall Weber, U.S. Pat. No. 4,946,182, August 1990, followed with an even more versatile boom type hitch. Those, and other hitches with similar capability, are readily adaptable for use with the present invention. Strap winches integral within small booms will offer a convenient and lightweight solution for raising the tongue to a hitch for many users.

The present invention is usually attached to the vehicle to be towed before it is attached to the tow truck so this hitch device conforms to all terrain conditions. The tow truck or the carrier attaches to the hitch device. Powered wheel-lifts often cause damage. Young, U.S. Pat. No. 5,951,235, September 1999, describes problems that all in the industry face and offers a powered solution to it. The present invention, a manually maneuvered hitch device, is powerless to cause damage to a vehicle and can perform similar tasks.

Under the best conditions tow truck operation is seldom without some physical effort. Sophisticated self-loading towing equipment requires the operator to check and perhaps secure the load before departing on a high-speed tow on public roadways. Most towing units still require installation of wheel chocks and retaining straps or chains. The present invention recognizes that fact and includes such tasks in the assembly of the wheel-lift hitch onto the vehicle to be towed. Many wreckers and tow trucks now carry towing dollies that require assembly, often at accident scenes. Light-duty embodiments of the present invention will be comparable in weight to the advertised weights of towing dollies and will require about the same time and effort to assemble.

It is understood that this device is adaptable to any hitch design that has an adequate vertical load rating in addition to adequate towing capacity. Pintle hooks and a variety of 5th wheel hitches are preferred over most ball hitches that are limited by low vertical load ratings. Gooseneck hitch adaptors can be used with models that have an adjustable length tongue and will offer better load transfer at some cost to convenience. Weight transfer hitches can be accommodated and truck mounted tongues are expected to be developed.

### BACKGROUND OF INVENTION—OBJECTS AND ADVANTAGES

The main object of this invention is to provide a wheel-lift device that, without moving parts and when assembled around wheels on an axle of a vehicle, becomes an appendage to that vehicle which can be used as a tongue to tow the vehicle as a cart behind a tow truck and to carry that vehicle on its own suspension.

A second object of the invention is to introduce a universal wheel-lift design that can be used to lift and carry an axle of almost all vehicles having at least 2 axles with wheels and tow that vehicle allowing it to ride on its own suspension.

A third object of the invention is to provide an automotive wheel-lift device to the industry that is easy to assemble and is lightweight.

Another object of the invention is to introduce a wheel-lift design that reduces the distance that the towing load is carried behind the axle of the tow truck thus providing safer and improved handling characteristics for the tow truck.

An additional object of the invention is to create a design that can be easily manufactured without specialized machinery.

A further object of the invention is to create a tool with simple and logical design, the proper use of which might be taught to almost any user without extensive repetition.

Additional objects and advantages of this invention will be set forth in the following description. They will in part be obvious from the description or may be learned by practice of the invention.

### SUMMARY

The present invention provides a wheel-lift hitch that is assembled around a vehicle axle for carrying that axle and serving as a tongue to tow that vehicle by a second vehicle.

### BRIEF DESCRIPTION OF THE SEVERAL VIEWS OF THE DRAWINGS

FIG. 1 is a perspective view of assembled wheel-lift device showing two chain attachment schemes and high and low brace modes. First chain attachment scheme and low brace mode is shown on device's left side, second chain attachment scheme and high brace mode is shown on device's right side.

FIG. 2 is an exploded view of extendable tongue assembly showing first and second arms and hitch housing.

FIG. 3 is a perspective view of brace assembly separated from rear chock assembly and showing second socket, brace oriented for low mounting mode.

FIG. 4 is a perspective view of brace assembled with rear chock in high mounting mode.

### REFERENCE NUMBERS USED IN DRAWINGS

20—Wheel-lift Device 22—Tongue Assembly

24—Transverse Beam Assembly 26—Rear Chock Assembly

28—Brace Assembly 30—Hitch

32—First Arm 34—First Arm Adjustment Holes

36—Hitch Housing 38—Channel

40—Web 42—Boss

44—First Pin 46—Second Arm

48—Cleat 50—Boss Latch Hole

52—First Chain Latch 54—Transverse Beam

56—Second Pin 60—First Chock

62—First Chock Latch 64—First Socket

66—Second Chain Latch 68—Anchor

70—Leg 72—Second Chock

74—Third Chain Latch 76—Second Socket

78—Socket Latch 80—Brace

82—Mounting Lug 84—Hinge

86—Brace Extension 88—Brace Latch

90—Brace Adjustment Holes 92—Grab Hook

94—First Chain 96—Second Chain

98—Chain Binder 100—Lifting Hook

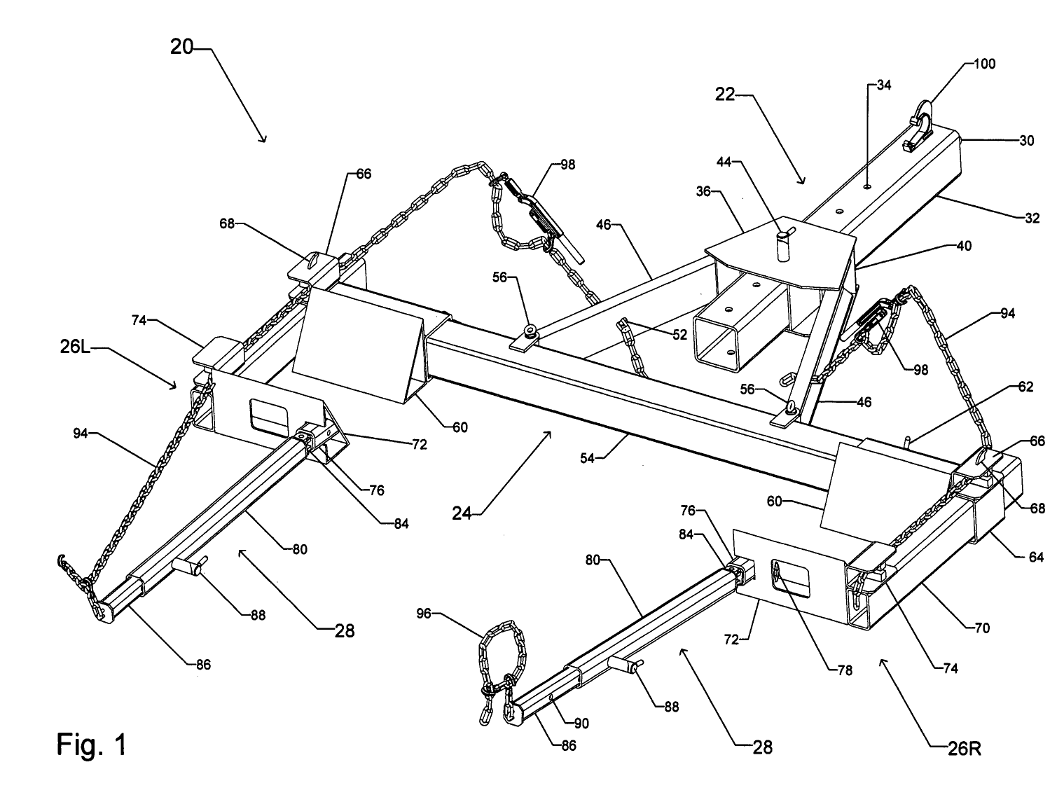

### DETAILED DESCRIPTION—FIGS. 1-4

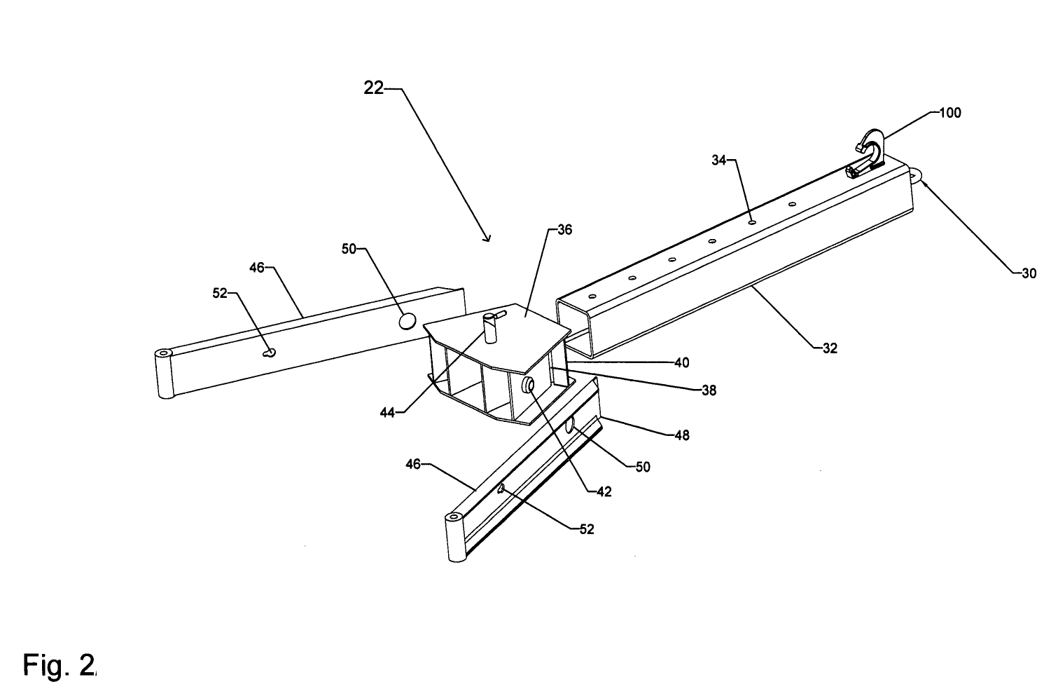

This wheel-lift device (20) uses a rigid “Y”-shaped tongue assembly (22) constructed from four components and shown connecting with transverse beam assembly (24) in FIG. 1. Tongue assembly (22), shown in exploded view in FIG. 2, provides adjustable tongue length by joining a first arm (32) with two second arms (46) within hitch housing (36). It is assembled by first attaching a second arm (46) to transverse beam assembly (24) using pin (56). Second arm (46) is aligned with channel (38) formed by top and bottom plates of hitch housing (36) and cleat (48) is inserted behind web (40). Housing (36) is further secured after inserting boss (42) into boss latch hole (50). The other second arm (46), not yet attached to transverse beam assembly (24), is then aligned with opposite channel (38) of hitch housing (36), cleat (48) is inserted behind web (40), and boss latch hole (50) encircles boss (42). The partially assembled tongue is rotated on pin (56) and secured in place to transverse beam (24) by another pin (56). First arm (32) connects hitch (30) to hitch housing (36) by arm latch (44) engaging one of several first arm adjustment holes (34).

Two attachment schemes are illustrated in FIG. 1. In either scheme tongue assembly (22) is connected to transverse beam assembly (24) and positioned ahead of tires of vehicle to be towed. First chocks (60 L & R) are adjustably mounted over ends of transverse beam (54), held in place by chock latch (62), mostly obscured except for right handle by first chocks (60) in FIG. 1. Rear chock assemblies (26) are inserted from the back into first sockets (64). Brace assemblies (28) are inserted into second sockets (76) and secured using socket latches (78). One or two chains may be used on each side of vehicle to secure wheel-lift hitch device depending on which attachment scheme is used.

In the first scheme a first chain (94) is connected to vehicle at a transport anchor point, and coursing forward, is connected by grab hook (92) to brace assembly (28). Brace assembly (28), extending rearward from second socket (76) within rear chock assembly (26L), is thereby attached to vehicle. First chain (94) continues forward through third chain latch (74). Chain binder (98), hooked between anchor (68) and first chain (94) ahead of third chain latch (74), slides leg (70L) within first socket (64) pulling first chain (94) taut. First chain (94) is secured there using second chain latch (66). Chain binder (98) is removed and reattached to first chain (94) as it courses further forward from second chain latch (66) over a suspension or chassis component of vehicle to first chain latch (52). First chain (94) is pulled taut there and secured for transport by chain binder (98). Brace latch (88) is not engaged because length of brace assembly (28) is maintained by first chain (94).

A second chain attachment scheme uses two chains, a first chain (94) latched into third chain latch (74), pulled forward by chain binder (98) hooked to anchor (68), thereby pulling second chock (72) against tire and tire against first chock (60). First chain (94) is secured within second chain latch (66) and chain binder (98) removed. First chain (94) courses forward over chassis or suspension components, pulled taut by chain binder (98) securing front of wheel-lift device (20). Second chain (96) looped around a frame, chassis, or suspension component, connects to brace assembly (28) by grab hook (92). Brace latch (88) is secured within one of several brace adjustment holes (90). Brace assembly (28) is secured within second socket (76) by socket latch (78) and replaces rearmost segment of first chain (94) between vehicle and second chock (72) for securing wheel-lift device (20) to vehicle at the rear.

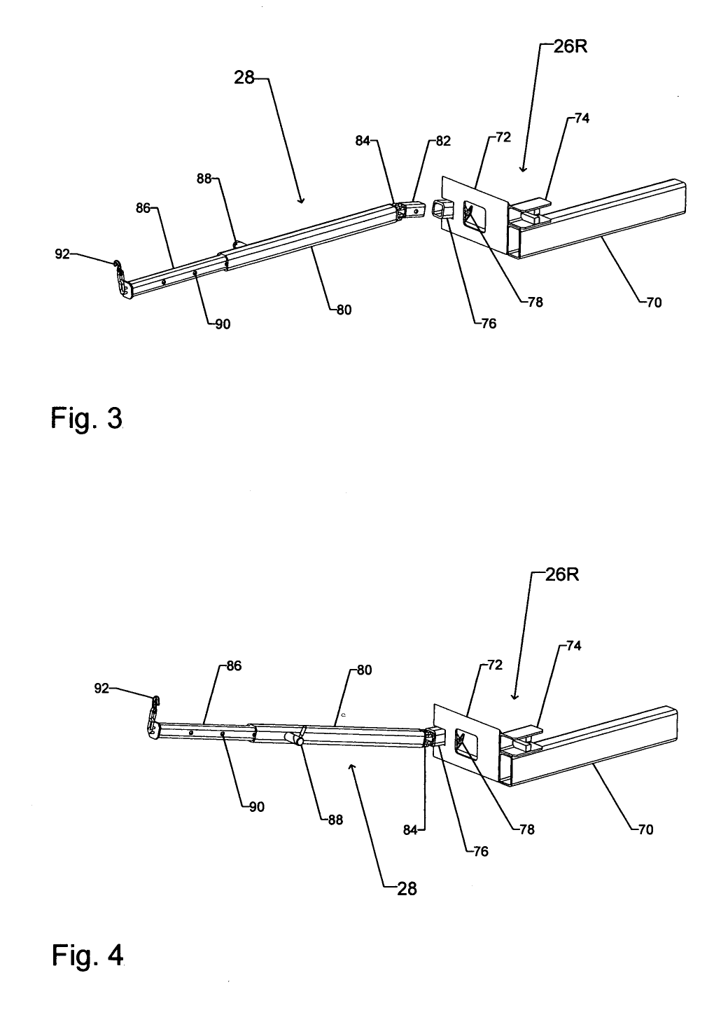

Brace assemblies (28) are illustrated in FIGS. 3 and 4, and further adapt hitch to a variety of vehicles using hinges (84) and brace extensions (86). Grab hook (92) can be attached to vehicle at a suitable anchor within a large area of vehicle chassis. Hinge (84) provides brace (80) with an arc of movement of at least 60 degrees from brace mounting lugs (82). Brace extension (86) adds more than half additional length to brace assembly (28) providing a choice of anchors to secure wheel-lift device (20) to most vehicles. Brace mounting lugs (82) join braces (80) at hinge (84) in which hinge pin is fixed at a small angle from vertical. Second socket (76) is tilted downward to the front at a similar angle within rear chock assembly (26). Braces (80) are changed between low and high attachment modes by rotating braces at second socket (76) 180 degrees. Low mounting mode is shown in FIG. 3 in which brace (28) extends rearward from second socket (76) in the same plane as leg (70).

FIG. 4 shows brace assembly (28) attached to rear chock assembly (26) in high mounting mode, angling upward by the sum of angles of hinge (84) and second socket (76) from plane of leg (70). Angling brace assembly (28) upward facilitates attachment of wheel-lift device (20) for use with high-clearance vehicles. Brace assemblies (26) are interchangeable left to right for installation between modes and so brace latch (88) can be accessible from alongside the vehicle.

Either chain attachment scheme can be used with brace assemblies (28) in either low or high mounting modes. It is expected that this wheel-lift device (20) will be constructed in various sizes including one large enough for use with Class 7 and 8 heavy trucks and commercial buses. Brace assemblies (28) extending rearward from the inner end of chock assemblies (26 L & R) pass behind fuel tanks, running boards, and other frame-mounted equipment common on large trucks. After connecting wheel-lift device (20) securely to vehicle for towing, no other contact with vehicle is required. Tow truck using equipment found on most towing and recovery vehicles is used to engage lift hook (100) and raise hitch (30) into a pintle hook fixed to the tow truck. This reduces the possibility of damage from equipment contact with towed vehicle. Wheel-lift device (20) does not pivot under vehicle like other wheel-lift devices, further reducing the possibility of damage.

Lifting equipment used to raise wheel-lift device (20) may range from a wrecker boom with winch to industrial lifting equipment such as knuckle-boom loaders. Wheel-lift device (20) enables damage-free towing to be accomplished without using dedicated towing or wrecker equipment.

Commercial trailer towing vehicles equipped with adjustable hitches may engage hitch (30) at ground level and raise load to towing position in a manner regularly used for modular housing and mobile home towing. “Second tows” and intercity tows seldom require additional equipment.

Wheel-lift device (20) can replace truck-mounted wheel-lifts on car carriers having slide-back bodies, substantially reducing equipment weight and equipment cost. A pintle hook or equivalent hitch fixed to the carrier frame is the only equipment needed for using this device. Carrier body is used as a lifting device by connecting a short recovery strap between carrier winch cable and lift hook (100), strap providing necessary flexibility to raise load to a height above pintle hook fixed to chassis. Sliding carrier body provides forward and rearward movement to pull wheel-lift device (20) fixed to vehicle forward to engage hitch (30) into pintle hook. Vehicle weight is transferred to carrier at hitch (30) rather than at the towed vehicle's wheels like conventional stinger wheel-lifts, thus reducing weight transferred to car carrier's rear axle. Because wheel-lift device (20) is of a size and form that can be carried attached to truck frame between axles for transport, no equipment weight is carried behind axle.

### CONCLUSIONS, RAMIFICATIONS, AND SCOPE OF INVENTION

The present invention provides a universal attachment scheme for vehicles having at least four wheels on at least two axles using a wheel-lift device. Components are generally of a size and weight that can be handled by one person. It is expected that proper use of this device can be easily taught to users.

The present invention carries less weight on the tow truck's axle and more vehicle weight on the vehicle's trailing axle compared to a conventional wrecker. Weight transfer is accomplished at the front rather than at the rear of the towing arm or tongue. It allows shorter and lighter vehicles to carry the same load and reduces leverage that load has on a tow truck.

The present invention provides a selection of capacities to accommodate most vehicles that can be licensed for use on public roadways. This should make modern towing equipment more widely available in smaller markets and in rural areas. It may benefit consumers by increasing the number of vehicles having damage-free towing equipment available to them.

Industry figures suggest less than one third of vehicle tow calls require the use of winches or recovery booms. Industry figures suggest that less than 20% of an average car carrier's revenue is realized from towing a second vehicle on a wheel-lift. One wheel-lift device (20) can be used with all trucks in a fleet. Reducing initial cost and weight while maintaining the same or increasing towing capability benefits users.

The present invention will allow a large percentage of towing to be accomplished using smaller and lighter tow trucks. Less vehicle weight requires less power and fuel to perform a task. The present invention is energy efficient.

1. A wheel-lift device forming a rigid tongue for hitching a vehicle to a tow truck, and pulling said vehicle on a trailing axle, said device comprising:
(a) a tongue having a first arm, a hitch housing, and two second arms connecting a hitch to a transverse beam;
(b) said first arm rigidly attaching said tow truck to said housing;
(c) said second arms rigidly connecting said housing to said beam;
(d) said second arms having first chain latches;
(e) said beam having arm mounting brackets, first wheel chocks, second chain latches, and first sockets for holding legs;
(f) said legs having second wheel chocks, third chain latches, and second sockets for holding braces;
(g) said braces extending rearward with chain hooks at distal ends;
(h) means for releasable attaching said vehicle to said wheel lift for towing.

2. A rigid wheel-lift device as defined in claim 1, the tongue further comprising:
(a) a housing joining said first arm to said second arms;
(b) said first arm adjustable for length within said housing;
(c) said housing having a trapezoidal shape;
(d) plates forming the top and bottom of said housing;
(e) means for rigidly joining said first and second arms within said housing.

3. A rigid wheel-lift device as defined in claim 1, wherein said housing further comprising:
(a) bosses fixed to sides of said housing;
(b) slots incorporated into sides of said housing;
(c) providing a means for rigidly attaching said second arms to said housing.

4. A rigid wheel-lift device as defined in claim 1, wherein said second arms further comprising:
(a) cleats engaging slots within said housing;
(b) latch holes engaging fixed bosses on said housing;
(d) providing a means for rigidly attaching said second arms to said housing.

5. A rigid wheel-lift device as defined in claim 1, wherein said second wheel chocks further comprising:
(a) said third chain latch fixed to said leg at said second wheel chock;
(b) said second socket fixed within said second wheel chock;
(c) means for securing said braces within said second socket.

6. A rigid wheel-lift device as defined in claim 1, wherein said braces further comprising:
(a) said braces having lugs incorporating vertical hinges and selectively latched within said second sockets;
(b) said braces having telescoping elements extending rearward behind said vertical hinges;
(c) means to connect said braces to said vehicle.

7. A rigid wheel-lift device as defined in claim 1, wherein the attachment means comprises chains attached to anchor points on said vehicle and further attaching to said wheel-lift device by said chain latches, thereby fastening said vehicle to said rigid wheel-lift device.
